(19) United States
(12) Patent Application Publication
(10) Pub. No.: US 2008/0229125 A1
(43) Pub. Date: Sep. 18, 2008

(54) POWER MANAGING METHOD OF A SCHEDULING SYSTEM AND RELATED SCHEDULING SYSTEM

(76) Inventors: Tson-Yee Lin, Taipei City (TW); Chang-Hung Lee, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 12/042,337

(22) Filed: Mar. 5, 2008

(30) Foreign Application Priority Data
Mar. 16, 2007 (TW) 096109228

(51) Int. Cl. G06F 1/26

(52) U.S. Cl. 713/300

(57) ABSTRACT

A scheduling system includes a main processor, a micro control unit and a power supply. The main processor has a first memory module for storing a plurality of scheduled times. The micro control unit has a second memory module for storing a first scheduled time of the plurality of scheduled times provided by the first memory module and a timer for providing a real time. A corresponding power managing method includes: (a) starting the micro control unit; (b) the micro control unit determining whether the first scheduled time is stored in the second memory module according to a schedule flag; (c) the micro control unit determining a correlation between the first scheduled time and the real time; and (d) the micro control unit controlling the power supply to power on or power off the main processor of the scheduling system according to determined results in step (b) and step (c).

### BACKGROUND OF THE INVENTION

1. Field of the Invention

The present invention relates to a power managing method of a scheduling system and a related scheduling system, and more specifically, to a power managing method of a record scheduling system so as to prevent a record scheduling function of the record scheduling system from losing its efficacy due to a power failure and a related record scheduling system.

2. Description of the Prior Art

Many electronic products have a scheduling function, namely a function of performing a scheduled procedure at a specific time. For example, there is usually a record scheduling function built in a recorder. Through predetermining a specific time and a specific channel, the record scheduling function can make it more convenient for a user to record a TV program at the specific time. For a record scheduling system comprising a central processing unit, it needs to continue being in a working mode so as to perform a recording at a scheduled time. Thus, the power consumption of the record scheduling system is high. Please refer to FIG. 1. FIG. 1 is a functional block diagram of a record scheduling system 10 according to the prior art. The record scheduling system 10 comprises a power supply 12 connected to an exterior power source 14, a main processor 16 electrically connected to the power supply 12, and a micro control unit 18 electrically connected to the power supply 12 and the main processor 16. The power supply 12 is used for receiving power transmitted from the exterior power source 14 to provide the record scheduling system 10 with power. The main processor 16 is used for controlling the record scheduling system 10. The micro control unit 18 comprises a timer 20 for calculating a real time. The record scheduling system 10 further comprises an interior power source 22 connected to the micro control unit 18. The interior power source 22 is used for providing the micro control unit 18 with power to prevent the real time from being lost when a power failure occurs or the power supply 12 is not connected to the exterior power source 14. The interior power source 22 can be a battery. In such a manner, the record scheduling system 10 can enter a standby mode first for saving power consumption before a scheduled recording time. After the record scheduling system 10 enters a standby mode, the record scheduling system 10 must be powered on before the scheduled recording time so as to prevent a missing operation of a recording.

The record scheduling system 10 further comprises a memory module 24 connected to the main processor 16. The memory module 24 can be an EEPROM (Electrically Erasable Programmable Read-Only Memory). The memory module 24 is used for storing plenty of sets of scheduled recording times. Then, a scheduled recording time closest to the real time is stored in the micro control unit 18, and the micro control unit 18 powers on the main processor 16 so as to perform a recording at the scheduled recording time closest to the real time. After the recording is completed, the main processor 16 stores a next scheduled recording time into the micro control unit 18 and transmits a power-off command to the micro control unit 18. After receiving the power-off command, the micro control unit 18 powers off the main processor 16 to make the record scheduling system 10 enter a standby mode. Then, the record scheduling system 10 continues being in the standby mode until the next scheduled recording time comes.

However, if a power failure occurs at the scheduled recording time, the recording fails to be completed. When the record scheduling system 10 is provided with power again, the micro control unit 18 does not power on the main processor 16 because the scheduled recording time has passed by, and thus a next scheduled recording time is also not stored into the micro control unit 18. In such a manner, the whole scheduled recordings predetermined by the user will fail to be performed just due to one power failure. For solving the said problem, the prior art utilizes the following method. Please refer to FIG. 2. FIG. 2 is a flowchart of a method for managing a record scheduling function of the record scheduling system 10 according to the prior art. The method comprises the following steps.

Step 100: The record scheduling system 10 is electrically connected;

Step 102: The micro control unit 18 powers on the main processor 16;

Step 104: The main processor 16 transmits a next scheduled recording time to the micro control unit 18;

Step 106: The main processor 16 transmits a power-off command to the micro control unit 18;

Step 108: The micro control unit 18 powers off the main processor 16 after receiving the power-off command;

Step 110: The record scheduling system 10 enters a standby mode;

Step 112: Determine whether the real time calculated by the timer 20 of the micro control unit 18 conforms to the next scheduled recording time. If so, go to Step 114; if not, go back to Step 110;

Step 114: The micro control unit 18 powers on the main processor 16 so as to perform a scheduled recording;

Step 116: End.

More description for the said steps is provided as follows. First, after the record scheduling system 10 is electrically connected, e.g. after the power supply 12 of the record scheduling system 10 is connected to the exterior power source 14 to receive power transmitted from the exterior power source 14, the micro control unit 18 powers on the main processor 16 automatically. Next, the main processor 16 transmits the next scheduled recording time to the micro control unit 18 and then transmits the power-off command to the micro control unit 18 to control the micro control unit 18 to power off the main processor 16. After powering off the main processor 16, the record scheduling system 10 enters the standby mode. When it is determined that the real time calculated by the timer 20 of the micro control unit 18 conforms to the next scheduled recording time, the micro control unit 18 powers on the main processor 16 so as to control the record scheduling system 10 to perform the scheduled recording. On the contrary, if it is determined that the real time calculated by the timer 20 of the micro control unit 18 does not conform to the next scheduled recording time, namely the real time does not arrive at the next scheduled recording time, the record scheduling system 10 continues being in the standby mode. As mentioned above, once the record scheduling system 10 is electrically connected, the micro control unit 18 powers on the main processor 16 automatically. In such a manner, even if a scheduled recording time is not predetermined, e.g. when the record scheduling system 10 is electrically connected at the first time, a long period of time is still required to complete a power-on procedure of the record scheduling system 10 because the record scheduling system 10 performs the steps in FIG. 2. This situation not only causes the user to misjudge easily that the record scheduling system 10 crashes, but also reduces efficiency of the record scheduling system 10.

### SUMMARY OF THE INVENTION

Therefore, the present invention provides a method for managing a scheduling system so as to prevent a scheduling function of the scheduling system from losing its efficacy due to a power failure and a related scheduling system to solve the aforementioned problems.

A power managing method of a scheduling system, the scheduling system including a main processor, a micro control unit and a power supply, the main processor having a first memory module for storing a plurality of scheduled times, the micro control unit having a second memory module for storing a first scheduled time of the plurality of scheduled times provided by the first memory module and a timer for providing a real time, includes: (a) starting the micro control unit; (b) the micro control unit determining whether the first scheduled time is stored in the second memory module according to a schedule flag; (c) the micro control unit determining a correlation between the first scheduled time and the real time; and (d) the micro control unit controlling the power supply to power on or power off the main processor of the scheduling system according to determined results in step (b) and step (c).

According to one aspect of the present invention, the method further includes determining whether the micro control unit has been reset according to a reset flag after starting the micro control unit.

In another aspect of the present invention, the method further includes the micro control unit powering on the main processor to generate a message to inform a user of resetting the real time when the micro control unit has been reset.

In another aspect of the present invention, the micro control unit determining whether the first scheduled time is stored in the second memory module according to the schedule flag includes the micro control unit controlling the power supply to power off the main processor so as to make the scheduling system enter a standby mode when the schedule flag is equal to 0.

In another aspect of the present invention, the micro control unit determining whether the first scheduled time is stored in the second memory module according to the schedule flag includes the micro control unit determining the correlation between the first scheduled time and the real time when the scheduled flag is equal to 1.

In another aspect of the present invention, the micro control unit determining the correlation between the first scheduled time and the real time includes the micro control unit controlling the power supply to power off the main processor so as to make the scheduling system enter a standby mode when the first scheduled time is later than the real time.

In another aspect of the present invention, the micro control unit determining the correlation between the first scheduled time and the real time includes the micro control unit controlling the power supply to power on the main processor and storing a second scheduled time of the plurality of scheduled times provided by the first memory module into the second memory module when the first scheduled time is earlier than the real time. The second scheduled time is later than the real time.

In another aspect of the present invention, the micro control unit determining the correlation between the first scheduled time and the real time includes the micro control unit controlling the power supply to power on the main processor to perform a scheduled procedure corresponding to the first scheduled time when the first scheduled time conforms to the real time.

In another aspect of the present invention, the scheduled procedure is a scheduled recording.

In another aspect of the present invention, the power managing method further includes the micro control unit controlling the power supply module to power off the main processor so as to make the scheduling system enter a standby mode after the scheduled procedure is finished.

In another aspect of the present invention, the micro control unit further includes an interior power source for providing the timer with power when the power supply is turned off.

A scheduling system is further disclosed. A scheduling system includes a main processor for performing a scheduled procedure, the main processor having a first memory module for storing a plurality of scheduled times; a micro control unit electrically connected to the main processor for determining whether a first scheduled time is stored in the second memory module according to a schedule flag and whether the first scheduled time conforms to the real time so as to control the power supply to power on or power off the main processor, the micro control unit having a second memory module for storing the first scheduled time provided by the first memory module and a timer for providing the real time; and a power supply electrically connected to the main processor and the micro control unit for providing the scheduling system with exterior power; wherein the micro control unit controls the power supply to power on the main processor of the scheduling system to perform the scheduled procedure when the schedule flag is equal to 1 and the micro control unit determines the first scheduled time conforms to the real time.

According to one aspect of the present invention, the micro control unit is used for determining whether the micro control unit has been reset according to a reset flag.

In another aspect of the present invention, the scheduling system further includes an input interface for inputting a time into the timer to reset the real time when the micro control unit has been reset.

In another aspect of the present invention, the micro control unit controls the power supply to power off the main processor so as to make the scheduling system enter a standby mode when the micro control unit determines the first scheduled time is later than the real time.

In another aspect of the present invention, the scheduling system is a record scheduling system and the scheduled procedure is a scheduled recording.

In another aspect of the present invention, the micro control unit controls the power supply to power on the main processor and the main processor stores a second scheduled time of the plurality of scheduled times into the second memory module of the micro control unit when the micro control unit determines the first scheduled time is stored in the second memory module and the first scheduled time is earlier than the real time. The second scheduled time is later than the real time.

In another aspect of the present invention, the micro control unit controls the power supply to power off the main processor so as to make the scheduling system enter a standby mode after the main processor stores the second scheduled time into the second memory module of the micro control unit.

In another aspect of the present invention, the micro control unit further includes an interior power source for providing the timer with power when the power supply is turned off.

In another aspect of the present invention, the interior power source is a battery.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a record scheduling system according to the prior art.

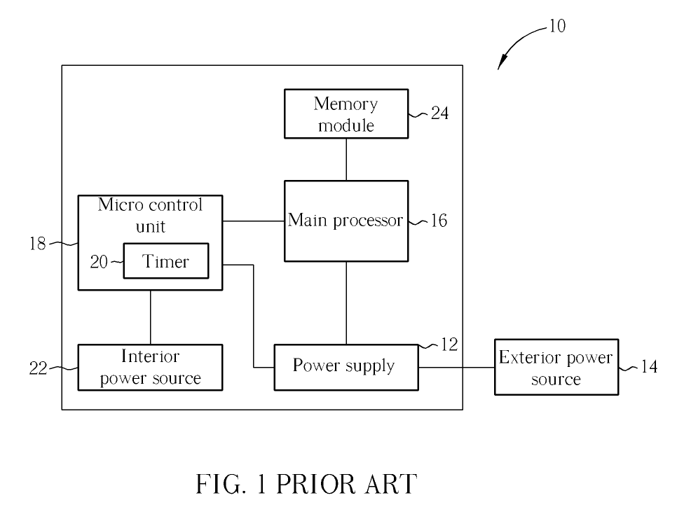

FIG. 2 is a flowchart of a method for managing a record scheduling function of the record scheduling system in FIG. 1.

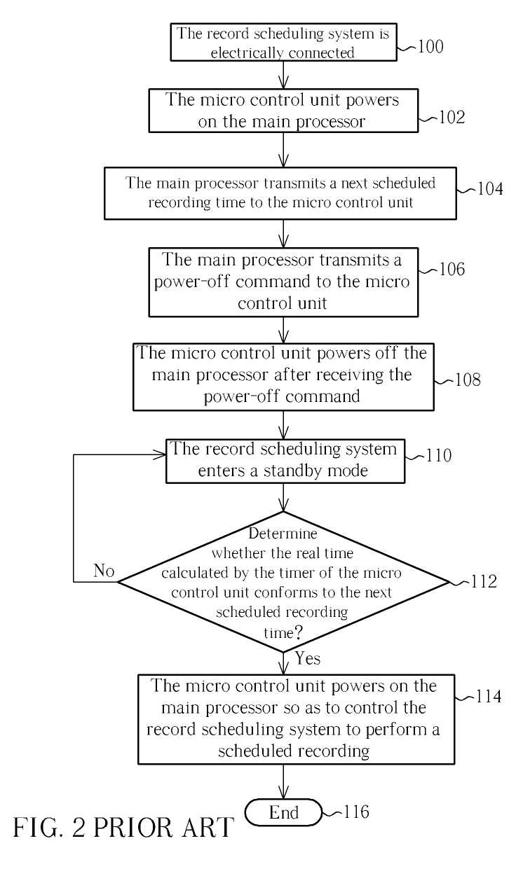

FIG. 3 is a functional block diagram of a scheduling system according to the present invention.

FIG. 4 is a flowchart of a power managing method of the scheduling system in FIG. 3.

### DETAILED DESCRIPTION

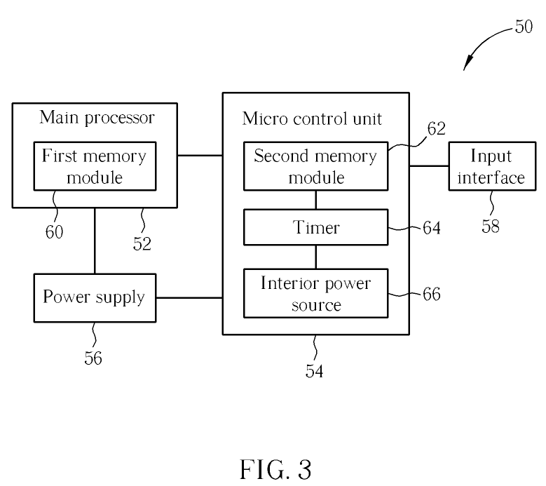

Please refer to FIG. 3. FIG. 3 is a functional block diagram of a scheduling system 50 according to the present invention. The scheduling system 50 according to the present invention can be applied to a system which needs to be scheduled to perform a scheduled procedure, such as a record scheduling system, an alarm clock system, a security system (be powered on to perform a monitoring procedure at a specific time), a robot system (be powered on to perform a scheduled action at a specific time), etc. Description for a scheduled recording is provided as follows. As for the other scheduled procedures mentioned above, they are similar to the scheduled recording and description thus will be omitted herein. The scheduling system 50 can be a record scheduling system. The scheduling system 50 comprises a main processor 52, a micro control unit 54, a power supply 56, and an input interface 58. The main processor 52 is used for performing a scheduled procedure. The main processor 52 has a first memory module 60 for storing a plurality of scheduled times. The micro control unit 54 has a second memory module 62 and a timer 64. The second module 62 is used for storing the first scheduled time provided by the first memory module 60. The timer 64 is used for providing a real time. The micro control unit 54 is electrically connected to the main processor 52 for determining whether the first scheduled time is stored in the second memory module according to a schedule flag and whether the first scheduled time conforms to the real time so as to control the power supply 56 to power on or power off the main processor 52. Further, the micro control unit 54 is also used for determining whether the micro control unit 54 has been reset according to a reset flag, and the input interface 58 is used for inputting a time into the timer 64 to reset the real time when the micro control unit has been reset. The power supply 56 is electrically connected to the main processor 52 and the micro control unit 54 for providing the scheduling system 50 with exterior power. In addition, the micro control unit 54 comprises an interior power source 66 for providing the timer 64 with power so as to prevent the real time from being lost when a power failure occurs or the power supply 56 is turned off. The interior power source 66 can be a battery. In such a manner, the scheduling system 50 can enter a standby mode first for saving power consumption before the first scheduled time. After the scheduling system 50 enters the standby mode, the scheduling system 50 needs to be powered on before the first scheduled time so as to prevent a missing operation of a scheduled recording.

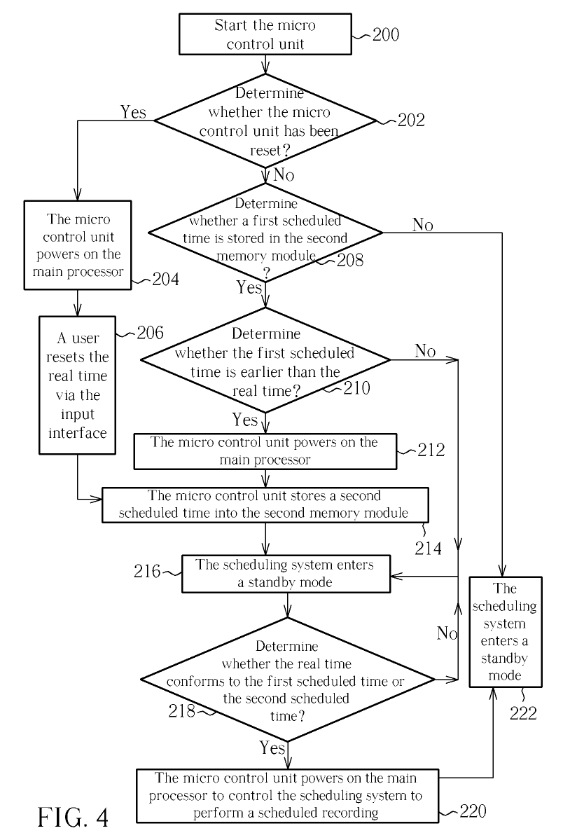

Please refer to FIG. 4. FIG. 4 is a flowchart of a power managing method of the scheduling system 50 according to the present invention. The power managing method comprises the following steps.

Step 200: Start the micro control unit 54;

Step 202: The micro control unit 54 determines whether the micro control unit 54 has been reset. If so, go to Step 204; if not, go to Step 208;

Step 204: The micro control unit 54 powers on the main processor 52;

Step 206: A user resets the real time via the input interface 58;

Step 208: The micro control unit 54 determines whether a first scheduled time is stored in the second memory module 62. If so, go to Step 210; if not, go to Step 222;

Step 210: The micro control unit 54 determines whether the first scheduled time is earlier than the real time. If so, go to Step 212; if not, go to Step 220;

Step 212: The micro control unit 54 powers on the main processor 52;

Step 214: The micro control unit 54 stores a second scheduled time into the second memory module 62;

Step 216: The scheduling system 50 enters a standby mode;

Step 218: The micro control unit 54 determines whether the real time conforms to the first scheduled time or the second scheduled time. If so, go to Step 220; if not, go back to Step 216;

Step 220: The micro control unit 54 powers on the main processor 52 to perform a scheduled recording;

Step 222: The scheduling system 50 enters into a standby mode.

More description for the aforementioned steps is provided as follows. After starting the micro control unit 54, the first step is to determine whether the micro control unit 54 has been reset according to a reset flag stored in the micro control unit 54. For example, when the power supply 56 of the scheduling system 50 has not been connected to the exterior power source for a long period of time and the interior power source 66 runs out of power, a specific value can be written into the reset flag to indicate that the micro control unit 54 has been reset. In other words, if the micro control unit 54 has been reset, it means that the scheduling system 50 has been not electrically connected for a long period of time and power of the interior power source 66 has run out. At this time, the micro control unit 54 powers on the main processor 52 first, and then notifies the user of resetting the real time via the input interface 58 to prevent a wrong real time. In addition, there is no scheduled time stored in the micro control unit 54 since the micro control unit 58 has been reset. Therefore, Step 214 needs to be performed to store a next scheduled time into the micro control unit 54. However, if the micro control unit 54 has been not reset yet, it means that information stored in the micro control unit 54 is not lost. In this circumstance, it is necessary to further determine whether a scheduled time is stored in the second memory module 62 of the micro control unit 54.

The present invention determines whether the scheduling system 50 still has a scheduled recording to be performed according to a schedule flag. For example, after the user predetermines a scheduled time, a specific value can be written into the schedule flag accordingly. That is to say, if the user has predetermined a scheduled time, the schedule flag can be set as number of 1. On the contrary, if not, the schedule flag can be set as number of 0. Next, the main processor 52 transmits the schedule flag to the micro control unit 54. Then, the micro control unit 54 determines whether the scheduling system 50 has a scheduled recording to be performed according to the schedule flag, namely whether the first scheduled time is stored in the second memory module 62 of the micro control unit 54. If it is determined that the scheduling system 50 has no scheduled recording to be performed, go to Step 222. That is to say, the scheduling system 50 enters the standby mode directly. On the contrary, if it is determined that the scheduling system 50 has a scheduled recording to be performed, it is necessary to further compare the first scheduled time with the real time.

Afterward, if the micro control unit 54 determines that the first scheduled time is later than the real time, it means that the real time has not arrived at the first scheduled time. At this time, the scheduling system 50 enters the standby mode (Step 216) and then continues being in the standby mode until the first scheduled time comes. But if the micro control unit 54 determines that the first scheduled time conforms to the real time, the micro control unit 54 controls the power supply 56 to power on the main processor 52 so as to perform a scheduled procedure corresponding to the first scheduled time. Further, if the micro control unit 54 determines that the first scheduled time is earlier than the real time, it means that the first scheduled time has passed by. That is to say, the latest scheduled recording fails to be performed. At this time, updating the schedule time is necessary.

Since the first scheduled time has passed by, the micro control unit 54 controls the power supply 56 to power on the main processor 52 and stores a second scheduled time of the plurality of scheduled times provided by the first memory module 60 into the second memory module 62. Next, the scheduling system 50 enters a standby mode and then continues being in the standby mode until the real time provided by the timer 64 of the micro control unit 54 conforms to the second scheduled time, the micro control unit 54 controls the power supply 56 to power on the main processor 52 so as to control the scheduling system 50 to perform a scheduled procedure corresponding to the second scheduled time. But if the real time provided by the timer 64 of the micro control unit 54 does not conform to the second scheduled time, the scheduling system 50 continues being in the standby mode.

Compared with the prior art, the present invention can prevent a scheduled procedure (such as a scheduled recording) of a scheduling system from failing to be performed due to a power failure. In addition, the present invention can also increase the booting speed of the scheduling system since the micro control unit does not power on the main processor when the scheduling system is electrically connected in a non-scheduling state. Even if the scheduling system is electrically connected in a scheduling state, the present invention can also determine whether storing a new scheduled time to the micro control unit is necessary according to a determined result of whether the latest scheduled time has passed by so as to prevent a scheduled procedure from failing to be performed. Therefore, the present invention can improve efficiency and accuracy of a scheduling system greatly.

Those skilled in the art will readily observe that numerous modifications and alterations of the device and method may be made while retaining the teachings of the invention.

What is claimed is:

1. A power managing method of a scheduling system, the scheduling system comprising a main processor, a micro control unit and a power supply, the main processor having a first memory module for storing a plurality of scheduled times, the micro control unit having a second memory module for storing a first scheduled time of the plurality of scheduled times provided by the first memory module and a timer for providing a real time, the power managing method comprising:
(a) starting the micro control unit;
(b) the micro control unit determining whether the first scheduled time is stored in the second memory module according to a schedule flag;
(c) the micro control unit determining a correlation between the first scheduled time and the real time; and
(d) the micro control unit controlling the power supply to power on or power off the main processor of the scheduling system according to determined results in step (b) and step (c).

2. The power managing method of claim 1 further comprising determining whether the micro control unit has been reset according to a reset flag after starting the micro control unit.

3. The power managing method of claim 2 further comprising the micro control unit powering on the main processor to generate a message to inform a user of resetting the real time when the micro control unit has been reset.

4. The power managing method of claim 1, wherein the micro control unit determining whether the first scheduled time is stored in the second memory module according to the schedule flag comprises the micro control unit controlling the power supply to power off the main processor so as to make the scheduling system enter a standby mode when the schedule flag is equal to 0.

5. The power managing method of claim 1, wherein the micro control unit determining whether the first scheduled time is stored in the second memory module according to the schedule flag comprises the micro control unit determining the correlation between the first scheduled time and the real time when the scheduled flag is equal to 1.

6. The power managing method of claim 1, wherein the micro control unit determining the correlation between the first scheduled time and the real time comprises the micro control unit controlling the power supply to power off the main processor so as to make the scheduling system enter a standby mode when the first scheduled time is later than the real time.

7. The power managing method of claim 1, wherein the micro control unit determining the correlation between the first scheduled time and the real time comprises the micro control unit controlling the power supply to power on the main processor and storing a second scheduled time of the plurality of scheduled times provided by the first memory module into the second memory module when the first scheduled time is earlier than the real time, the second scheduled time being later than the real time.

8. The power managing method of claim 1, wherein the micro control unit determining the correlation between the first scheduled time and the real time comprises the micro control unit controlling the power supply to power on the main processor to perform a scheduled procedure corresponding to the first scheduled time when the first scheduled time conforms to the real time.

9. The power managing method of claim 8, wherein the scheduled procedure is a scheduled recording.

10. The power managing method of claim 8 further comprising the micro control unit controlling the power supply module to power off the main processor so as to make the scheduling system enter a standby mode after the scheduled procedure is finished.

11. The power managing method of claim 1, wherein the micro control unit further comprises an interior power source for providing the timer with power when the power supply is turned off.

12. A scheduling system comprising:
a main processor for performing a scheduled procedure, the main processor having a first memory module for storing a plurality of scheduled times;
a micro control unit electrically connected to the main processor for determining whether a first scheduled time is stored in the second memory module according to a schedule flag and whether the first scheduled time conforms to the real time so as to control the power supply to power on or power off the main processor, the micro control unit having a second memory module for storing the first scheduled time provided by the first memory module and a timer for providing the real time; and
a power supply electrically connected to the main processor and the micro control unit for providing the scheduling system with exterior power;
wherein the micro control unit controls the power supply to power on the main processor of the scheduling system to perform the scheduled procedure when the schedule flag is equal to 1 and the micro control unit determines the first scheduled time conforms to the real time.

13. The scheduling system of claim 12, wherein the micro control unit is used for determining whether the micro control unit has been reset according to a reset flag.

14. The scheduling system of claim 13 further comprising an input interface for inputting a time into the timer to reset the real time when the micro control unit has been reset.

15. The scheduling system of claim 12, wherein the micro control unit controls the power supply to power off the main processor so as to make the scheduling system enter a standby mode when the micro control unit determines the first scheduled time is later than the real time.

16. The scheduling system of claim 12, wherein the scheduling system is a record scheduling system and the scheduled procedure is a scheduled recording.

17. The scheduling system of claim 12, wherein the micro control unit controls the power supply to power on the main processor and the main processor stores a second scheduled time of the plurality of scheduled times into the second memory module of the micro control unit when the micro control unit determines the first scheduled time is stored in the second memory module and the first scheduled time is earlier than the real time, the second scheduled time being later than the real time.

18. The scheduling system of claim 17, wherein the micro control unit controls the power supply to power off the main processor so as to make the scheduling system enter a standby mode after the main processor stores the second scheduled time into the second memory module of the micro control unit.

19. The scheduling system of claim 12, wherein the micro control unit further comprises an interior power source for providing the timer with power when the power supply is turned off.

20. The scheduling system of claim 19, wherein the interior power source is a battery.
